(19) United States
(12) Patent Application Publication
(10) Pub. No.: US 2026/0070020 A1
(43) Pub. Date: Mar. 12, 2026

(54) HOLLOW FIBER ELEMENT, SEPARATION MEMBRANE MODULE, AND METHOD FOR PRODUCING DEHYDRATED ORGANIC COMPOUND

(71) Applicant: UBE Corporation, Ube-shi (JP)

(72) Inventors: Kensuke FURUE, Ube-shi (JP); Tomonori KANOUGI, Ube-shi (JP); Shota KITAI, Ube-shi (JP); Hina ARIYOSHI, Ube-shi (JP); Michihiko SASAKI, Ube-shi (JP)

(21) Appl. No.: 19/311,434

(22) Filed: Aug. 27, 2025

(30) Foreign Application Priority Data
Sep. 6, 2024 (JP) 2024-153974

(51) Int. Cl. B01D 63/02; B01D 53/22; B01D 53/26; C08G 59/24; C08G 59/32; C08G 59/38; C08G 59/50

(52) U.S. Cl. CPC B01D 63/023; B01D 53/228; B01D 53/268; C08G 59/245; C08G 59/3227; C08G 59/38; C08G 59/5033; B01D 2053/224; B01D 2257/80; B01D 2313/042

(57) ABSTRACT

A hollow fiber element for a separation membrane module, including a plurality of hollow fiber membranes, and a tube sheet which is formed of a cured product of an epoxy composition and fixes and adheres at least one of the ends of the hollow fiber membranes. The cured product has a breaking strength retention of 75% or higher as measured in the form of a 0.2 mm thick film, the breaking strength retention (%) is defined as B₁/B₀×100, B₁ is a breaking strength (MPa) measured at 23° C. after the film is immersed in ethanol at 130° C. for 120 hours; and B₀ is a breaking strength (MPa) measured at 23° C. before immersion in ethanol.

This application claims priority to Japanese Patent Application No. 2024-153974, filed Sep. 6, 2024, the entire content of which is incorporated herein by reference.

### TECHNICAL FIELD

This invention relates to a hollow fiber element composed of a bundle of a large number of hollow fiber membranes with selective permeability that are integrally potted in a tube sheet at their end.

### BACKGROUND ART

Hollow fiber separation modules are widely used for their industrial advantages, including not only high surface area-to-volume ratios but also high pressure resistance and excellent self-supporting properties.

In a hollow fiber separation membrane module, the bundle of hollow fibers with selective permeability is generally fixed and adhered at least one end thereof by a tube sheet formed, e.g., of a cured epoxy composition.

Patent literature 1 discloses a hollow fiber element for organic vapor separation. The tube sheet of this element is made of a cured material having a glass transition temperature of 160° C. or higher, a minimum elongation at break of 7.0% or more, and an elution ratio of less than 5%. Patent literature 1 also discloses a hollow fiber element having sufficient durability to maintain air-tight separation between the internal and external spaces of the hollow fiber membranes even in use in the presence of high temperature and pressure organic vapor.

### CITATION LIST

Patent literature 1: US 20120031831A

### SUMMARY OF INVENTION

The inventors have found that the cured resin composition of patent literature 1 has room for improvement on durability in terms of resistance to elution and cracking at high temperatures, particularly in the presence of high temperature and pressure organic vapor.

The invention provides a hollow fiber element for a separation membrane module, comprising
a plurality of hollow fiber membranes, and
a tube sheet which is formed of a cured product of an epoxy composition and fixes and adheres at least one of the ends of the hollow fiber membranes,
the cured product having a breaking strength retention of 75% or higher as measured in the form of a 0.2 mm thick film,
the breaking strength retention (%) being defined as B₁/B₀×100,
wherein B₁ is a breaking strength (MPa) measured at 23° C. after the film is immersed in ethanol at 130° C. for 120 hours; and
B₀ is a breaking strength (MPa) measured at 23° C. before immersion in ethanol.

The invention also provides separation membrane module comprising
a pressure vessel, and
the hollow fiber element according to claim 1 housed in the pressure vessel.

The invention also provides a gas separation system comprising the separation membrane module.

The invention also provides a method for producing a dehydrated organic compound including using the gas separation system.

### BRIEF DESCRIPTION OF DRAWINGS

FIG. 1 is a cross-section showing the structure of an embodiment of the separation membrane module of the invention.

FIG. 2 schematically illustrates a method for making the hollow fiber element of the invention.

FIG. 3 schematically illustrates the cracking test performed in Examples and Comparative Examples.

### DESCRIPTION OF EMBODIMENTS

The invention will be described on the basis of its preferred embodiments.

The description will explain in detail a resin composition for a tube sheet of a hollow fiber element (hereinafter referred to as “resin composition for a hollow fiber element tube sheet”), a hollow fiber element, a separation membrane module, and a method for producing a dehydrated organic compound using the separation membrane module.

### I. Resin Composition for a Hollow Fiber Element Tube Sheet and Hollow Fiber Element

As used herein, the term “hollow fiber element” refers to a structure composed of a bundle of numerous hollow fiber membranes having at least selective permeability, at least one end of the bundle being fixed and adhered by a tube sheet made of a cured product of an epoxy composition. The fixing and adhering is carried out in such a manner that the end of the individual hollow fibers is open. The epoxy composition cured product in this embodiment is specifically a cured product of a resin composition for a hollow fiber element tube sheet containing an epoxy composition and a curing agent.

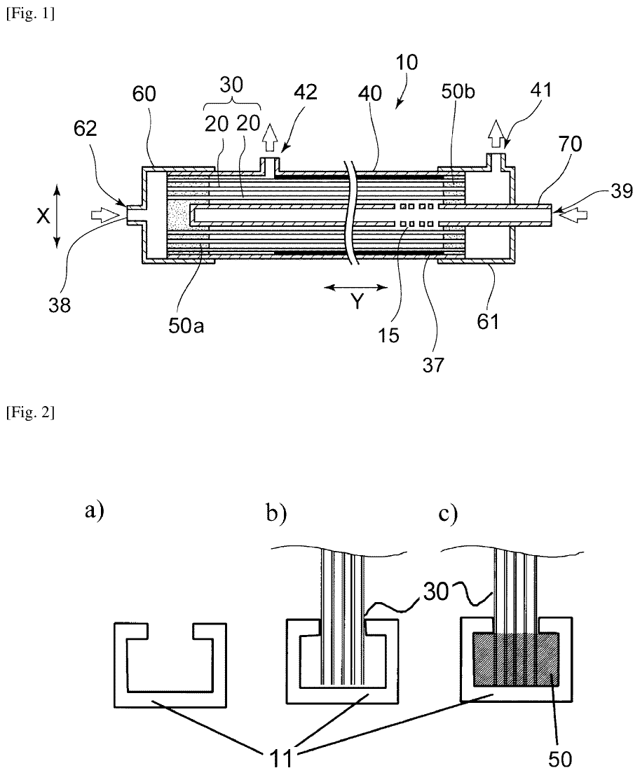

FIG. 1 is a schematic cross-section showing a separation membrane module 10 including the hollow fiber element of the embodiment and a pressure vessel 40. The separation membrane module 10 of FIG. 1 is used for gas separation. The pressure vessel 40 includes a cylinder open at both ends and two end caps closing the respective open ends of the cylinder. The pressure vessel 40 has, on its outer frame, a mixed gas inlet port 38, a carrier gas inlet port 39, a permeate gas outlet port 42, and a retentate gas outlet port 41.

The pressure vessel 40 contains a fiber bundle 30 consisting of numerous hollow fiber membranes 20 with selective permeability as a hollow fiber element having the following structure. The fiber bundle 30 is fixed in a first tube sheet 50a at the end that is closer to the permeate gas outlet port 42 in the Figure, and in a second tube sheet 50b at the other end that is closer to the retentate gas outlet port 41 in the Figure to assemble a hollow fiber element. Both the first and second tube sheets 50a and 50b are made of a cured product of resin composition for a hollow fiber element tube sheet. The individual hollow fibers 20 making up the fiber bundle 30 pass through the tube sheets 50a and 50b and are fixed thereby in such a manner that their ends are open. In the separation membrane module 10 shown in FIG. 1, a mixed gas is fed from the mixed gas inlet port 38, and a permeate gas, that has passed through the hollow fiber membranes 20, is discharged from the permeate gas outlet port 42, while the retentate (non-permeate) that has not passed through the hollow fiber membranes 20 is discharged from the retentate gas outlet port 41.

As stated previously, conventional resin compositions for a hollow fiber element tube sheet have room for improvement of durability of their cured products in terms of resistance to elution and cracking at high temperatures, particularly in the presence of organic vapor under a high temperature and pressure condition. To address this problem, the inventors have discovered that a resin composition for a hollow fiber element tube sheet that satisfies a specific parameter requirement is more durable under the above conditions than conventional compositions.

Specifically, a cured resin composition forming a hollow fiber element tube sheet of the invention has a breaking strength retention R₁ of at least 75%, preferably 80% or higher, more preferably 85% or higher, and even more preferably 90% or higher, as measured in the form of a 0.2 mm thick film. The breaking strength retention obtained in Examples of patent literature 1 was less than 75%. The breaking strength retention R₁ (%) is defined as B₁/B₀×100, where B₁ is the breaking strength (MPa) measured at 23° C. after the film is immersed in ethanol at 130° C. for 120 hours; and B₀ is the breaking strength (MPa) measured at 23° C. in an initial state before immersion in ethanol.

When cured, the resin composition for a hollow fiber element tube sheet that satisfies the above requirement of breaking strength retention provides a tube sheet that exhibits elution resistance in an organic compound, such as ethanol, and excellent toughness, making it resistant to cracking in high temperature and pressure conditions, especially even when exposed to high temperature and pressure organic vapor, such as ethanol vapor, followed by drying.

The breaking strength retention R₁ of the cured product of the resin composition for a tube sheet in the hollow fiber element of the invention may exceed 100% in cases where the immersion in ethanol causes minimal reduction in elastic modulus, resulting in increased elongation at break. Cracking of tube sheets tends to decrease with an increase in R₁, but R₁ is usually no greater than 120%.

The breaking strength B₁ of the cured product of the resin composition for a tube sheet in the hollow fiber element of the invention is preferably 30 MPa or higher, more preferably 35 MPa or higher, even more preferably 40 MPa or higher, and still more preferably 45 MPa or higher. Cracking of tube sheets tends to decrease with an increase in B₁; however, B₁ is usually 60 MPa or lower.

The cured product of the resin composition for a tube sheet in the hollow fiber element of the invention exhibits excellent toughness, preferably having the breaking strength B₀ of 30 MPa or higher, more preferably 35 MPa or higher, and even more preferably 40 MPa or higher. Cracking of tube sheets tends to reduce with an increase in B₀; however, B₀ is usually 60 MPa or lower.

The cured product of the resin composition for a tube sheet in the hollow fiber element of the invention preferably has an elution ratio of 2% or lower, more preferably 1.5% or lower, even more preferably 1% or lower, and still more preferably 0.5% or lower.

The term “elution ratio” refers to the percentage of weight loss that occurs when the cured resin composition is immersed in a high-temperature organic compound. In this invention, the weight loss is induced by immersion in 130° C. ethanol as a high-temperature organic compound. The specific method used to determine the elution ratio is described in Examples given later. A cured product with a low elution ratio exhibits high durability in the presence of high temperature and pressure organic vapor.

The elution ratio can be obtained by immersing a test piece having a thickness of approximately 0.2 mm, a length of 40 mm and a width of 6 mm by in 130° C. ethanol in an airtight vessel for 120 hours, dividing the dry weight change between before and after the immersion (weight loss) by the weight of the test piece before immersion, and multiplying the quotient by 100.

The resin composition for a tube sheet in the hollow fiber element of the invention preferably has high strength retention in high temperature environments. That is, the cured product of the resin composition for a tube sheet preferably has a high breaking strength retention R₂, specifically of 55% or higher, more preferably 60% or higher, even more preferably 65% or higher, and still more preferably 70% or higher, as measured in the form of a 0.2 mm thick film. The breaking strength retention R₂ (%) is defined as B₂/B₀×100, where B₂ is the breaking strength (MPa) measured at 23° C. after the film is maintained at 150° C. for 10 minutes under normal atmospheric pressure; and B₀ is the breaking strength (MPa) measured at 23° C. of the film in its initial state (before being maintained at 150° C. for 10 minutes).

The cured product of the resin composition for a tube sheet with the breaking strength retention R₂ in the above range exhibits excellent durability against high temperatures in the absence of organic vapor as well. Therefore, it is useful for applications other than organic vapor separation. Such applications include separating nitrogen and oxygen from air, separating carbon dioxide from mixed gases, such as natural gas and biogas, desiccating or humidifying air, separating hydrogen or helium from various mixed gases, desalinating seawater, producing ultrapure water, and removing bacteria, fungi, and viruses.

The higher the breaking strength retention R₂ of the resin composition for a tube sheet, the more preferred. However, it is usually 100% or lower.

The cured product of the resin composition for a tube sheet in the hollow fiber element of the invention preferably has a breaking strength B₂ of 20 MPa or higher, more preferably 23 MPa or higher, even more preferably 26 MPa or higher, and still more preferably 29 MPa or higher. The higher the breaking strength B₂ of the cured resin composition, the more preferred. However, it is usually 50 MPa or lower.

The breaking strength can be measured by a tensile test. The breaking strength as referred to in the invention is defined as the maximum nominal stress obtained by dividing the maximum load by the cross-sectional area of a test specimen before the test. The tensile test is carried out under the following conditions: a pull speed of 2 mm/min and an initial jaw separation of 20 mm. The test specimen may be made by curing the resin composition for a tube sheet or be cut from the tube sheet of a separation membrane module.

The test specimen for the tensile test, which is a 0.2 mm thick film, can be prepared by curing the resin composition for a tube sheet in the hollow fiber element under the following heat treatment conditions. For example, the resin composition is first heated at 60° C. for 15 hours to undergo primary curing. Then, the heating temperature is elevated to 90° C. at a rate of 0.25° C./min, at which the resin composition is heated for 2 hours, the temperature is further elevated to 120° C. at a rate of 0.25° C./min, at which the resin composition is heated for 2 hours, the temperature is furthermore elevated to 150° C. at a rate of 0.25° C./min, at which the resin composition is heated for 2 hours. Finally, the temperature is raised to 180° C. at a rate of 0.25° C./min, at which the resin composition is heated for 4 hours to complete the after-cure. The heat treatment is carried out in an atmospheric environment.

The resin composition for a tube sheet in the hollow fiber element in the invention contains an epoxy composition and a curing agent. As used herein, the term “epoxy composition” refers to a composition containing at least one compound having two or more epoxy groups, namely an epoxy compound. The curing agent includes a compound capable of curing the epoxy composition.

The terms used in the description regarding the resin composition for a hollow fiber element tube sheet are explained below.

As used herein, the term “cyclic structure” excludes an epoxy ring. The cyclic structure is preferably an aromatic ring.

In this description, the number of “ring structures” is counted as one for both a monocyclic ring and a fused ring system. The number of “rings” is counted as one for a monocyclic ring, and for a fused ring, the individual rings that make up the fused system are counted. For example, biphenyl has two cyclic structures and two rings. Naphthyl has one cyclic structure and two rings. Binaphthyl has two cyclic structures and four rings.

Regarding a linking group that connects rings, the “number of linking atoms in a linking group” refers to the number of atoms in the shortest path within the linking group between the rings. For example, the number of linking atoms in a linking group is zero in biphenyl, and one in bisphenol A. Regarding a linking group that connects a ring and an epoxy group, the “number of linking atoms in a linking group” refers to the number of atoms in the shortest path within the linking group between the ring and the epoxy group. For example, this number of linking atoms in a linking group is two in glycidyl phenyl ether.

In this description, when a linking group is a combination of an alkylene group and other divalent linking groups (e.g., —O—), the other divalent linking groups are not adjoining to each other.

In this description, unless otherwise noted, the linking groups and cyclic structures described below encompass those in which a hydrogen atom of any of the constituent groups, such as an alkylene group, is replaced by a substituent. Examples of the substituent include a halogen atom, a hydroxy group, an alkyl group, or a haloalkyl group. In this description, the halogen atom can be fluorine, chlorine, bromine, or iodine.

In this description, the term “hydrocarbon group” includes monovalent and divalent or higher valent hydrocarbon groups. Monovalent hydrocarbon groups include alkyl, alkenyl, cycloalkyl, cycloalkylalkyl, aryl, and arylalkyl. Examples of the alkyl group include methyl, ethyl, propyl, isopropyl, butyl, isobutyl, tert-butyl, amyl, isoamyl, tert-amyl, hexyl, isohexyl, and octyl.

Examples of the cycloalkyl group include cyclohexyl. The cycloalkylalkyl group is exemplified by cyclohexylethyl.

Examples of the alkenyl group include vinyl, 2-propenyl, 3-butenyl, 2-butenyl, 4-pentenyl, 3-pentenyl, 2-hexenyl, 3-hexenyl, 5-hexenyl, 2-heptenyl, 3-heptenyl, and 4-heptenyl. Examples of the aryl group include phenyl, methylphenyl, dimethylphenyl, ethylphenyl, and naphthyl.

Examples of the arylalkyl group include benzyl and phenethyl.

Divalent or higher valent hydrocarbon groups include those corresponding to the above-recited monovalent hydrocarbon groups, such as alkylene and arylene.

Examples of the alkylene groups include linear alkylene, such as methylene, ethylene, n-propylene, n-butylene, and hexylene, as well as branched alkylene, such as isopropylene, isobutylene, and 2-methylpropylene.

Examples of the arylene groups include the above-recited aryl groups with one hydrogen atom removed.

The epoxy composition used in the resin composition for a tube sheet in the hollow fiber element in the invention preferably contains (a1) 20 to 90 mass % of an epoxy compound having a cyclic structure and an epoxy equivalent weight of 110 or less and (a2) 10 to 60 mass % of an epoxy compound having a cyclic structure and an epoxy equivalent weight of 150 to 500. Containing two epoxy compounds that have a rigid structure due to their cyclic structures and differ from each other in crosslinking reactivity in a specific ratio, the the resin composition for a hollow fiber element tube sheet easily provides a cured product with the abovementioned breaking strength retention.

The epoxy equivalent weight can be determined in accordance with JIS K7236:2001.

The cyclic structure of the epoxy compound (a1) is a 5-or-greater-membered ring, including a monocyclic and a fused ring. From the standpoint of durability of the cured product of the resin composition at high temperatures, particularly in the presence of high temperature and pressure organic vapor, the number of the cyclic structures of the epoxy compound (a1) is preferably three or smaller, more preferably two or smaller, and even more preferably one.

When the epoxy compound (a1) has two or more cyclic structures, the cyclic structures are connected via a linking group L₁. When the epoxy compound (a1) has the structures a plurality of the cyclic structures are connected via the linking group L₁, examples of the linking group L₁ include a single bond, —O—, —S—, —NR¹¹—, —CO—, —SO₂—, C1-C5 alkylene, and combinations thereof. The number of linking atoms in the linking group L₁ is preferably 5 or fewer, more preferably 3 or fewer, and even more preferably 1 or fewer. R¹¹ is hydrogen or hydrocarbon with 1 to 10 carbon atoms, preferably with 5 or fewer carbon atoms, and more preferably with 4 or fewer carbon atoms.

While the cyclic structure of the epoxy compound (a1) is a 5-or-greater-membered ring, it is preferably an aromatic ring in terms of durability of the cured product of the resin composition at high temperatures, particularly in the presence of high temperature and pressure organic vapor. Known aromatic rings include hydrocarbon aromatic rings whose cyclic structure is composed of carbon atoms and heterocyclic aromatic rings whose cyclic structure is composed of carbon atoms and at least one hetero atom. Examples of the hydrocarbon aromatic rings include benzene, naphthalene, and anthracene. Examples of the heterocyclic aromatic rings include pyridine, pyrazine, pyrrole, quinoline, quinoxaline, furan, benzofuran, thiophene, benzothiophene, oxazole, thiazole, imidazole, pyrazole, indole, and carbazole. The cyclic structure of the epoxy compound (a1) is preferably a hydrocarbon aromatic ring to ensure the improvement in durability of the cured product of the resin composition at high temperatures, particularly in the presence of high temperature and pressure organic vapor. The hydrocarbon aromatic ring is preferably a benzene ring or a naphthalene ring, and more preferably a benzene ring.

The epoxy compound (a1) is preferably a compound having three or more epoxy groups on its cyclic structure to further improve the durability of the cured product of the resin composition at high temperatures, particularly in the presence of high temperature and pressure organic vapor. When an epoxy group is described as being “on” the cyclic structure, the epoxy group can be bonded to the atom constituting the ring either directly or via a linking group L₂. Examples of the linking group L₂ include —O—, —S—, —NR¹²—, —CO—, —CO—O—, —CO—NR¹²—, —CO—S—, —N═, a carbon atom, a C1-C7 alkylene group, and combinations thereof. The linking group L₂ is preferably —O—, —NR¹²—, —N═, C1-C7 alkylene, or a combination thereof, and more preferably a combination of —O— and C1-C7 alkylene or a combination of —N═ and C1-C5 alkylene. The number of linking atoms in the linking group L₂ is preferably 5 or fewer, more preferably 1 to 3, and even more preferably 2. R¹² is hydrogen or a C1-C10 hydrocarbon group, preferably hydrogen or C1-C3 hydrocarbon.

The epoxy compound (a1) can have any of a glycidyl group, an alicyclic epoxy group, and the like as an epoxy-containing group but preferably has a glycidyl group to further improve the durability of the cured product of the resin composition at high temperatures, particularly in the presence of high temperature and pressure organic vapor. The epoxy compound (a1) preferably has a glycidyl ether group and/or a glycidylamino group, particularly a glycidylamino group, as a glycidyl-containing group. The glycidylamino group is preferably bifunctional.

The epoxy compound (a1) has an epoxy equivalent weight of 110 or less, preferably 108 or less, more preferably 106 or less, even more preferably 104 or less, still more preferably 102 or less, and yet more preferably 100 or less; and preferably 70 or more, more preferably 75 or more, even more preferably 80 or more, still more preferably 85 or more, and yet more preferably 90 or more. When the epoxy equivalent weight of the epoxy compound (a1) is within the above range, the cured product of the resin composition exhibits excellent durability at high temperatures, particularly in the presence of high temperature and pressure organic vapor. The molecular weight of the epoxy compound (a1) is not limited but is preferably 180 to 450, more preferably 200 to 400, and even more preferably 240 to 350.

The epoxy compound (a1) is exemplified by a compound represented by formula (3):

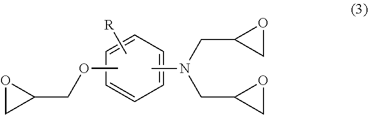

wherein R represents a C1-C3 alkyl group, a C1-C3 fluoroalkyl group, or hydrogen. The C1-C3 fluoroalkyl group includes trifluoromethyl, trifluoroethyl, pentafluoropropyl, hexafluoroisopropyl, and isopropyl.

To further improve the durability of the resulting cured product at high temperatures, particularly in the presence of high temperature and pressure organic vapor, the content of the epoxy compound (a1) in the epoxy composition is preferably 20 mass % or more, more preferably 23 mass % or more, even more preferably 25 mass %, and still more preferably 28 mass %. For the same purpose, the content of the epoxy compound (a1) in the epoxy composition is preferably 90 mass % or less, more preferably 89 mass % or less, even more preferably 88 mass % or less, and still more preferably 86 mass % or less.

To further improve the durability of the resulting cured product at high temperatures, particularly in the presence of high temperature and pressure organic vapor, the epoxy compound (a2) is preferably a bisphenol A epoxy compound.

The bisphenol A epoxy compound is exemplified by a compound represented by formula (4):

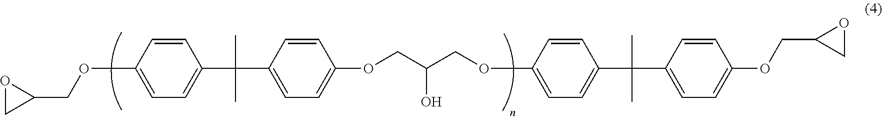

wherein n represents a number of from 0 to 100.

The epoxy compound (a2) has an epoxy equivalent weight of 150 or more. The epoxy equivalent weight of the epoxy compound (a2) may be 160 or more, 170 or more, or 180 or more. The epoxy equivalent weight of the epoxy compound (a2) is 500 or less, preferably 400 or less, more preferably 300 or less, even more preferably 250 or less, and still more preferably 200 or less.

To further improve the durability of the resulting cured product at high temperatures, particularly in the presence of high temperature and pressure organic vapor, the content of the epoxy compound (a2) in the epoxy composition is preferably 10 mass % or more, more preferably 13 mass % or more, and even more preferably 15 mass %. For the same purpose, the content of the epoxy compound (a2) in the epoxy composition is preferably 60 mass % or less, more preferably 50 mass % or less, even more preferably 40 mass % or less, and still more preferably 30 mass % or less.

The epoxy composition may further contain an epoxy compound different from the epoxy compounds (a1) and (a2). This optional epoxy compound is preferably a compound with a cyclic structure, particularly (a3) an epoxy compound having a cyclic structure and an epoxy equivalent weight of 95 or more and less than 150, preferably 105 or more and less than 150, more preferably more than 110 and less than 150. The content of the epoxy compound (a3) in the epoxy composition is preferably 0 to 60 mass %. When the epoxy compound (a1) has one ring, the epoxy compound (a3) to be combined with (a1) should preferably have two or more rings. Even when the epoxy compound (a3) with two or more rings has an epoxy equivalent weight of 110 or less, it is distinguished from the epoxy compound (a1) by the difference in the number of rings. The description of the amounts or ratios of the epoxy compounds (a1) and (a3) shall accord with this distinction.

The cyclic structure of the epoxy compound (a3) with an epoxy equivalent weight of 95 or more (preferably 105 or more, more preferably more than 110) and less than 150 can be an aliphatic ring or an aromatic ring, but is preferably an aromatic ring in terms of the effect on strength retention. Examples of the aromatic ring include those recited above for the epoxy compound (a1). The cyclic structure of the epoxy compound (a3) can be either a monocyclic or a fused ring. The epoxy compound (a3) may have a structure in which cyclic structures are connected to each other via a linking group L₄. Examples of the linking group L₄ bonding the rings include a single bond, —O—, —S—, —NR¹¹—, —CO—, —SO₂—, and C1-C7 alkylene, as well as combinations thereof. The number of linking atoms in the linking group L₄ is preferably 6 or smaller, more preferably 1 to 3, and even more preferably 1. The linking group L₄ is preferably alkylene, a combination of alkylene and —O—, —S—, —NR¹¹—, —CO—, —CO—NR¹¹—, or —CO—S—, —O—, —S—, —NR¹¹—, —CO—, or —SO₂—. The linking group L₄ preferably contains 12 or fewer carbon atoms, more preferably 7 or fewer.

To obtain excellent effect on strength retention, the cyclic structure in the epoxy compound (a3) is preferably a hydrocarbon aromatic ring, more preferably benzene or naphthalene, and even more preferably benzene. The number of the cyclic structures in the epoxy compound (a3) may be 1 or 2 or greater, but is preferably 2 or greater in terms of strength retention effect. This number is more preferably 2 to 4, and even more preferably 2 to 3, still more preferably 2.

The epoxy compound (a3) preferably has 1 or 2 or more cyclic structures with 2 or more epoxy groups on each cyclic structure; more preferably 1 or 2 or more cyclic structures with 2 or 3 epoxy groups on each cyclic structure; even more preferably 1 or 2 or more cyclic structures with 2 epoxy groups on each cyclic structure; and still more preferably 2 or more cyclic structures with 2 epoxy groups on each cyclic structure. When an epoxy group is described as being “on” a cyclic structure, the epoxy group can be bonded to the atom constituting the ring either directly or via a linking group L₂. Preferred examples of the linking group L₂ are the same as those recited above with reference to the epoxy compound (a1). The epoxy compound (a3) preferably has a glycidyl ether group and/or a glycidylamino group, particularly a glycidylamino group, as a glycidyl-containing group. The glycidylamino group is preferably bifunctional.

The epoxy compound (a3) preferably has an epoxy equivalent weight of less than 150, more preferably 140 or less, and even more preferably 130 or less; and preferably more than 110, more preferably 111 or more, and even more preferably 114 or more.

The epoxy compound (a3) preferably has a molecular weight of 1000 or less, more preferably 600 or less, and preferably 50 or more, and more preferably 80 or more.

The epoxy compound (a3) is exemplified by a compound represented by formula (5):

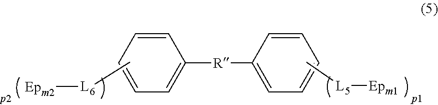

wherein Ep represents an epoxy group; R″ represents a methylene group or —C(R″′)₂—; R″′ each independently represents a C1-C3 alkyl group, a C1-C3 fluoroalkyl group, or a hydrogen atom; m1, p1, m2, and p2 each independently represent 1 or 2, provided that m1+p1=3 and m2+p2=3; L₅ represents an (m1+1)-valent group; and L₆ represents an (m2+1)-valent group. In formula (5), the number of atoms constituting L₅ and L₆ is preferably 2 or 3. When L₅ or L₆ is divalent, it is preferably a combination of methylene and —O—. When L₅ or L₆ is trivalent, it is preferably a combination of methylene and —N═. L₅ and L₆ are each preferably in the m- or p-position relative to R″.

For ease of further improving the toughness of a cured product and the durability of a cured product in the presence of high temperature and pressure organic vapor, the content of the epoxy compound (a3) in the epoxy composition is preferably such that the epoxy compounds (a1), (a2), and (a3) collectively account for 70% or more, more preferably 80% or more, even more preferably 90% or more, and still more preferably 95% or more, of the total mass of the epoxy composition.

Examples of the epoxy compound (a1) include triglycidyl derivatives of 4-aminophenol, 3-aminophenol, 2-aminophenol, 4-amino-m-cresol, 4-amino-o-cresol, 2-ethyl-4-aminophenol, 3-ethyl-4-aminophenol, and so on, and a triglycidyl derivative of 4-aminophenol, i.e., triglycidyl-4-aminophenol is particularly preferred.

Examples of the epoxy compound (a2) include jER825, jER827, jER828, and jER834 available from Mitsubishi Chemical Corp.; EPICLON 840 and EPICLON 850 from DIC Corp.; YD 127 and YD 128 available from NIPPON STEEL Chemical & Material Co., Ltd.; and ADEKA RESIN series EP-4100, EP-4300, EP-4400, EP-4520, and EP-4530 available from ADEKA Corp., and jER 828 (liquid bisphenol A epoxy compound) is particularly preferred.

Examples of the epoxy compound (a3) include tetraglycidyl diaminodiphenylmethane, N,N,N′,N′-tetraglycidyl-1,3-benzenebis(methaneamine), N,N,N′,N′-tetraglycidyl-1,4-benzenebis(methaneamine), N,N′-(cyclohexane-1,3-diylbismethylene)bis(diglycidylamine), and N,N′-(cyclohexane-1,4-diylbismethylene)bis(diglycidylamine), and with jER604 available from Mitsubishi Chemical Corp., ELM-434 available from Sumitomo Chemical Co., Ltd., and TETRAD-X and TETRAD-C available from Mitsubishi Gas Chemical Co., Inc. being preferred.

The curing agent of the resin composition is preferably an amine curing agent to obtain a cured product with high water resistance and excellent mechanical properties. The amine curing agent can be an aromatic amine compound, an aliphatic amine compound, or a combination thereof. The aliphatic amine compound includes an alicyclic amine compound. An aromatic amine compound is particularly preferred for ease of obtaining a cured product with high-temperature durability.

In order to obtain a strength retention effect at high temperatures, particularly in the presence of high temperature and pressure organic vapor, thereby to produce a cured product with a high breaking strength retention, the curing agent is preferably an amine compound having a structure represented by formula (1):

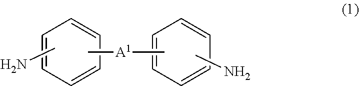

wherein A¹ represents a divalent linking group represented by any of formula (2-1), (2-2), (2-3), (2-4), and (2-5):

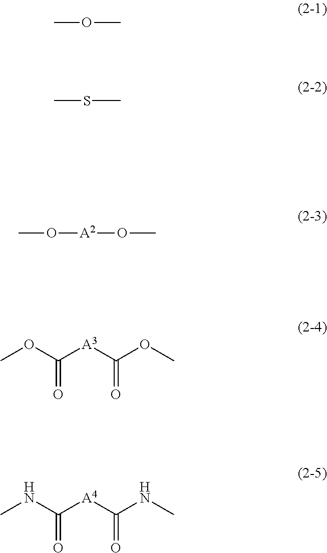

wherein A², A³, and A⁴ each independently represent a divalent organic group with 1 to 18 carbon atoms.

Examples of the C1-C18 organic group, as represented by A², A³, and A⁴, include alkylene, arylene, and a combination of alkylene and arylene, wherein at least one of the methylene groups that constitute the alkylene group may be replaced with —O—, —S—, —NR¹³—, —CO—, —CO—NR¹³—, —NR¹³—CO—, —CO—S—, or —S—CO—. This replacement preferably occurs with the methylene moiety forming the main chain of the linking group A², A³, or A⁴. R¹³ is a hydrogen atom or a C1-C10 hydrocarbon group, preferably a hydrogen atom or a C1-C5 hydrocarbon group.

Suitable examples of the C1-C18 organic group, as represented by A², A³, and A⁴, include a C2-C18 alkylene group and groups represented by formula (6-1) and (6-2):

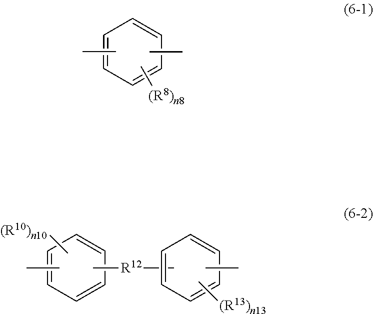

wherein R¹, R¹⁰, and R¹³ each independently represent a C1-C3 hydrocarbon group, a halogen atom, or a hydroxy group; n8, n10, and n13 each independently represent an integer of 0 to 4; R¹² represents a direct bond, a C1-C6 alkylene group, a phenylene, or a C7-C10 group composed of a combination of C1-C6 alkylene and phenylene. One or two or more the methylene moieties constituting the alkylene group may be replaced with —O—, —S—, —NR¹⁴—, —CO—, —CO—NR¹⁴—, or —NR¹⁴—CO—. This replacement preferably occurs with the methylene moiety forming the main chain of the linking group represented by R¹². R¹⁴ is a hydrogen atom or a C1-C10 hydrocarbon group, preferably a hydrogen atom or a C1-C5 hydrocarbon group.

Among the curing agents represented by formula (1), those in which A¹ is a divalent linking group of formula (2-1), (2-2), or (2-3) are preferred in that the resulting cured product exhibits excellent toughness to provide resistance to cracking and elution at high temperatures, particularly in the presence of high temperature and pressure organic vapor. Those in which A¹ is a divalent linking group of formula (2-1), (2-2), or (2-3) wherein A² is a group of formula (6-1) or (6-2) are more preferred. Those in which A¹ is a divalent linking group of formula (2-1) or (2-2) are even more preferred. Those in which A¹ is a divalent linking group of formula (2-1) are the most preferred.

In terms of low melting temperature and ease of handling, the aromatic curing agent of formula (1) preferably has at least one of the two amino groups in the m-position relative to the linking group A¹ bonded to the benzene ring, to which the at least one amino group is bonded. When one of the two amino groups is in the m-position relative to the linking group A¹ bonded to the benzene ring, to which the one amino group is bonded, the other amino group is preferably in the m- or p-position relative to the linking group A¹ bonded to the benzene ring, to which the other amino group is bonded.

The curing agent preferably has an active hydrogen equivalent weight of preferably 150 or less, more preferably 120 or less, even more preferably 110 or less, still even more preferably 80 or less, and still more preferably 60 or less; and preferably 20 or more, more preferably 30 or more, and even more preferably 40 or more. The active hydrogen equivalent weight is the equivalent of active hydrogen that reacts with the epoxy groups of the epoxy composition. The active hydrogen equivalent weight of an amine curing agent corresponds to its amine equivalent weight.

The curing agent, particularly the aromatic amine compound, is preferably used in a ratio of about 60% to 140%, more preferably 80% to 120%, of the stoichiometric amount calculated from the epoxy equivalent weight of the epoxy composition. Within this ratio of the curing agent, the resin composition for a hollow fiber element tube sheet cures sufficiently to form a strong tube sheet.

The resin composition for a hollow fiber element tube sheet used in the invention may contain optional components other than the aforementioned epoxy composition and curing agent. Examples of the optional components other than the aforementioned epoxy composition and curing agent includes resins other than the epoxy resin (epoxy compounds), metals, metal oxides, aluminosilicates, and carbonaceous materials. The total amount of the components other than the epoxy composition and curing agent may be, for example, 50 mass % or less, or 30 mass % or less, in the resin composition for a hollow fiber element tube sheet.

Specific examples of the amine compound having formula (1) include 4,4′-diaminodiphenyl ether, 3,3′-diaminodiphenyl ether, 3,4′-diaminodiphenyl ether, 4,4′-diaminodiphenyl sulfide, 3,3′-diaminodiphenyl sulfide, 3,4′-diaminodiphenyl sulfide, 1,4-bis(4-aminophenoxy)benzene, 1,3-bis(4-aminophenoxy)benzene, bis(4-aminophenoxy) terephthalate, and 1,4-bisN,N′(4-aminophenyl)terephthalamide, and 3,4′-diaminodiphenyl ether being preferred.

The cured product of the resin composition for a hollow fiber element tube sheet can be obtained by heat treating the uncured resin composition for a hollow fiber element tube sheet containing the epoxy composition and curing agent.

The hollow fiber element of the invention has a structure in which at least one end of a bundle of a plurality of hollow fiber membranes is fixed and adhered by a tube sheet formed of a cured product of the above-described resin composition for a hollow fiber element tube sheet. All the aforementioned preferred ranges for breaking strength retention, breaking strength, and elution ratio apply to the tube sheets used in the hollow fiber element of the invention.

The hollow fiber membrane with selective permeability for use in the hollow fiber element of the invention is made of materials suited to the substances being separated and separation conditions. For example, preferred materials include elastomers and glassy macromolecules, such as polybutadiene, polychloroprene, butyl rubber, silicone resins, polyethylene, polypropylene, ethylene-propylene copolymers, polystyrene, poly(4-methyl-1-pentene), polytetrafluoroethylene, polyvinylidene fluoride, tetrafluoroethylene-ethylene copolymers, polychlorotrifluoroethylene, cellulose acetate, polyvinyl chloride, polyvinyl alcohol, polymethyl methacrylate, polyamide, polysulfone, polyether sulfone, polyether ether ketone, polyimide, polyamide imide, polyether imide, polyphenylene sulfide, polyarylate, and polycarbonate. In particular, hollow fiber membranes made of polyimide, which excel in heat resistance, organic solvent resistance, and selective permeability, are preferred. Polyimide with an aromatic backbone is preferred, and hollow fiber membranes made of aromatic polyimide are more preferred. The term “aromatic polyimide” as used herein refers to polyimide in which both the acid dianhydride-derived and the diamine-derived moieties have an aromatic structure.

The hollow fiber membrane may have either a homogeneous structure or a heterogeneous structure, such as a composite membrane or an asymmetric membrane. Asymmetric membranes made of aromatic polyimide are the most suitable in terms of selectivity and permeability. Membranes with a thickness of 20 to 200 m and an outer diameter of 50 to 1000 m are suitably used.

The hollow fiber bundle used in the invention is a bundle consisting of a large number of selective hollow fiber membranes. Typically, about 100 to 1,000,000 hollow fiber membranes are bundled together. The shape of a hollow fiber bundle is not particularly limited. For instance, the hollow fiber membranes may be arrayed into a prismatic or a sheet-shaped bundle, and the tube sheet may be a rectangular parallelepiped. For ease of producing the hollow fiber element and for the pressure vessel's pressure resistance, a cylindrical hollow fiber bundle or a disk-shaped tube sheet is preferred. The hollow fibers may be substantially parallel to the axis or may be inclined at a certain angle. Preferably, the hollow fibers are bundled so as to be alternately arranged at angles of 5° to 30° to the axis, such that they cross each other.

The hollow fiber element of the invention may have one of the end of the hollow fiber element fixed by a tube sheet or may have both of the ends of the hollow fiber element fixed by a tube sheet. When both ends are fixed by the tube sheet, the individual hollow fibers may be occluded at one fixed end as long as the other fixed end remains open. When only one end is potted, the other end is configured so that the hollow fibers are not open by occluding the openings, folding back the hollow fibers, or using a like method. Preferably, the hollow fiber bundle is fixed at both ends in respective tube sheets, leaving the ends of the fibers open.

The hollow fiber element of the invention preferably has a distribution tube placed at almost the center of the hollow fiber bundle to introduce a gas. This gas to be introduced to almost the center of the fiber bundle is preferably a carrier gas. Since the purpose of the distribution tube is to evenly distribute the incoming gas across the entire bundle, the phrase “almost the center of the bundle” is not limited to the literal center, and the distribution tube can be positioned accordingly.

A preferred method for producing the hollow fiber element of the invention will next be described.

The hollow fiber element can be produced by a method known in the art. FIG. 2 is referred to. A hollow fiber bundle 30, composed of a predetermined number of hollow fiber membranes 20 with a predetermined length, with the distribution tube removed therefrom or remaining at almost the center thereof, is placed at a predetermined position in a cylindrical mold 11 (FIG. 2A) for molding a tube sheet at one end of the bundle. The bundle 30 and the mold 11 are held substantially vertical with the end of the bundle downward. This state is schematically illustrated. A predetermined amount of a resin composition for tube sheets is injected into the mold 11. Note that the composition for a hollow fiber element tube sheet is hereinafter referred to as “resin composition”. The state that the resin composition is injected is schematically illustrated.

Considering ease of molding, it is preferable that the resin composition be liquid at the temperature at which it is injected into the mold.

The viscosity of the resin composition to be cured is not particularly limited but is preferably in the range of 0.1 or more and less than 100 Pa·s at 40° C. The viscosity of the resin composition can be measured with a rotating viscometer. After the resin composition is injected into the mold, the mold and the fiber bundle are maintained at a given temperature to heat the resin composition. The heating temperature is suitably 100° C. or lower and preferably 30° to 80° C.

To obtain a satisfactory cured resin composition, the resin composition is preferably further heated at a temperature of 25° to 110° C. until fluidity is lost to achieve primary curing. Primary curing is preferably performed by slowly heating the resin composition at a temperature rise rate of 0.1° C./min to 10° C./min after being heated at 110° C. or lower.

To prevent changes in physical properties of the cured resin composition during operation of the resulting separation membrane module, the primary curing is preferably followed by post-curing. Post-curing is preferably carried out by finally heat treating the resin composition at a final temperature of or above the module operating temperature, e.g., 120° C. or higher, more preferably 160° C. or higher.

After post-curing, the cured product of the resin composition (tube sheet) is cut to expose the opening of each hollow fiber membrane, thereby making a hollow fiber element in which the hollow fibers are fixed by the tube sheet with their end open. In the case where both ends of the hollow fiber bundle are fixed by the respective tube sheets, fixing one end of the hollow fiber bundle in the tube sheet as described above is followed by fixing the other end in another tube sheet in the same manner.

In the case where a carrier gas guide film 38 (see FIG. 1) is provided around the hollow fiber bundle, a resin film is wrapped around the bundle and adhesively attached to the end portion of the bundle where a tube sheet is to be formed. The end portion of the bundle, wrapped in the resin film, is then placed in the mold as shown in FIG. 2B to form the tube sheet.

### II. Separation Membrane Module

A separation membrane module of the invention includes one or two or more hollow fiber element of the invention housed in a pressure vessel. The separation membrane module of the invention is highly gas-tight owing to the durability of the tube sheet of the hollow fiber element at high temperatures, especially in the presence of organic vapor at high temperatures and pressures. The pressure vessel preferably has at least a mixed gas inlet port, a permeate gas outlet port, and a retentate gas outlet port and may optionally have a carrier gas inlet port. The separation membrane module configuration is not particularly limited and includes bore-side feed, shell-side feed, carrier gas use, and no carrier gas use. The bore-side feed module is configured such that the mixed gas inlet port and the retentate gas outlet port lead to the internal space of every hollow fiber membrane, while the permeate gas outlet port leads to the outer space of the hollow fiber membranes, as illustrated in FIG. 1. In this instance, the carrier gas inlet port also leads to the outer space of the hollow fiber membranes.

The pressure vessel material includes metals, resins, and fiber-reinforced plastics, and is chosen according to the installation site environment and circumstances of use. For applications requiring pressure and thermal resistance, metals that combine strength with moldability/formability are preferred, and stainless steel is preferred. From the perspective of improving the pressure resistance of the pressure vessel, it is preferable that the cross-sectional shape of the pressure vessel be circular or elliptical, and more preferably circular. In the module, the space leading to the internal space of hollow fiber membranes and the space leading to the outer space of the hollow fiber membranes are isolated from each other to maintain gas tightness.

### III. Gas Separation System

The gas separation system of the invention includes at least one separation membrane module of the invention. Examples of the gas separation system of the invention include a system in which a plurality of the separation membrane modules are arranged in parallel, sharing a mixed gas inlet port, a retentate gas outlet port, a permeate gas outlet port, and, optionally, a carrier gas inlet port and a system in which a plurality of the separation membrane modules are connected in series.

### IV. Gas Separation Method or Method for Producing Dehydrated Organic Compound

The gas separation method of the invention using the gas separation system of the invention, particularly the method for producing a dehydrated organic compound will then be described. A dehydrated organic compound is typically obtained through the separation of water-containing organic vapor. In such cases, the organic vapor tends to penetrate the tube sheet because of severe high-temperature and high-pressure conditions, which often results in tube sheet cracking.

In the production of a dehydrated organic compound with the gas separation system, either a bore-side feed, where the internal space of the hollow fiber membrane is the primary side, or a shell-side feed, where the outer space of the hollow fiber membrane is the primary side, can be used.

Whichever the bore-side feed or the shell-side feed is adopted, a water-containing organic vapor mixture fed from the mixed gas inlet port to the primary side of the gas separation membrane module flows in contact with the surface of the hollow fiber membrane and discharged out of the module from the retentate gas outlet port. Meanwhile, the permeate gas having passed through the hollow fiber membrane is discharged from the module through the permeate gas outlet port located in the secondary side space. Since the hollow fiber membrane is selectively permeable, the permeate gas having passed through the membrane is rich in a highly permeant component, while the retentate gas discharged from the retentate outlet port contains the highly permeant component in a decreased concentration. The module operates so that the partial pressure of the highly permeant component is lower in the permeate side than in the feed side. When the separation membrane module of FIG. 1 is used, for instance, a water-containing organic vapor mixture is introduced from the mixed gas inlet port 38 through the opening of the individual hollow fiber membranes into the internal space of the hollow fiber membranes 20. As the water-containing organic vapor mixture flows in the internal space of the hollow fiber membranes, the highly permeant component is selectively allowed to pass through the membranes to become a permeate gas, which migrates into the space between the tube sheets 50a and 50b, where the hollow fiber bundle is housed. The retentate (non-permeate) gas enters the space to which the other open end of the individual hollow fiber membranes is open and is discharged from the retentate gas outlet port 41. For instance, a dehydrated organic compound is collected as a retentate separated from a water-enriched permeate.

In the above method, permeation may be accelerated by making a carrier gas flow along the secondary side surface of the membrane. In this system, it is preferable for the carrier gas to flow counter-currently to the water-containing organic vapor mixture stream with the hollow fiber membrane therebetween. The carrier gas is not limited as long as it is free of the highly permeant component or it contains the highly permeant component at a lower partial pressure than the retentate gas. Examples of the carrier gas include nitrogen and air. A portion of the retentate gas that has been deprived of the highly permeant component may be returned to the carrier gas inlet port for use as a carrier gas.

In the embodiment shown in FIG. 1, the module 10 incorporates a carrier gas guide film 37. The film 37 is situated around the outer circumference of the hollow fiber bundle 30, extending from the point of carrier gas introduction to the discharge point. The module 10 also incorporates a distribution tube 70. The tube 70 pierces the tube sheet 50b, which is located nearer to the carrier gas feed side, and runs in almost the center of the hollow fiber bundle 30. The tube 70 has holes 15 bored in the vicinities of the tube sheet 50b, via which the internal space of the distribution tube 70 and the hollow fiber bundle are interconnected. When a carrier gas is used, it is introduced through the carrier gas inlet port 39 of the distribution tube 70. Then, the carrier gas is led through the holes 15 to the space between the tube sheets 50a and 50b, where the hollow fibers are arranged. The carrier gas flows in contact with the outer surface of the hollow fiber membranes 20 and is discharged from the permeate gas outlet port 42 together with the permeate gas from the hollow fiber membranes. Therefore, the flow of the mixed gas feed stream and the flow of the carrier gas within the module are countercurrent to each other, with the separation membranes situated therebetween.

In the method of producing a dehydrated organic compound with the gas separation system of the invention, the mixed gas to be treated is suitably a mixed vapor of water vapor and organic vapor. The organic compound preferably has a boiling point of 0° to 200° C. under normal pressure. This is a practical approach, considering the operating temperature range of the hollow fiber membrane, the equipment for vaporizing organic mixed vapor by superheating, the equipment for condensing and recovering a separated and purified component, and the ease of handling.

Examples of the organic compound with a boiling point of 0° to 200° C. under normal pressure include aliphatic alcohols, such as methanol, ethanol, n-propanol, 2-propanol, n-butanol, s-butanol, t-butanol, and ethylene glycol; alicyclic alcohols, such as cyclohexanol; aromatic alcohols, such as benzyl alcohol, organic carboxylic acids, such as formic acid, acetic acid, propionic acid, and butyric acid; organic acid esters, such as butyl acetate and ethyl acetate; ketones, such as acetone and methyl ethyl ketone; cyclic ethers, such as tetrahydrofuran and dioxane; organic amines, such as butylamine and aniline; and mixtures of these compounds.

The method for producing a dehydrated organic compound with the separation system of the invention involves vaporization of a water-containing organic compound through heating. This process is achieved using, for example, an evaporator or distillator, resulting in a water-containing organic vapor mixture having normal pressure or as pressurized to about 0.1 to 10 atm (gauge pressure) to be fed to the separation membrane module. The water-containing organic vapor mixture being fed to the module preferably has a temperature of 80° C. or higher, more preferably 100° C. or higher, and even more preferably 120° C. or higher.

The disclosure also includes the following clauses.
1. A resin composition for a hollow fiber element tube sheet including an epoxy composition and a curing agent, wherein
   a cured product of the resin composition has a breaking strength retention R₁ of 75% or higher as measured in the form of a 0.2 mm thick film, the breaking strength retention R₁ (%) being defined as B₁B₀×100,
   wherein B₁ is a breaking strength (MPa) measured at 23° C. after the film is immersed in ethanol at 130° C. for 120 hours; and
   B₀ is a breaking strength (MPa) measured at 23° C. before immersion in ethanol.
2. The resin composition for a hollow fiber element tube sheet of clause 1, wherein the cured product has an alcohol elution ratio of 2% or lower when immersed in ethanol at 130° C. for 120 hours in the form of a 0.2 mm thick film.
3. The resin composition for a hollow fiber element tube sheet of clause 1 or 2, wherein the cured product has a breaking strength B₀ of 30 MPa or more at 23° C. as measured in the form of a 0.2 mm thick film.
4. The resin composition for a hollow fiber element tube sheet of any one of clauses 1 to 3, wherein the epoxy composition includes
   (a1) 20 to 90 mass % of an epoxy compound having a cyclic structure and an epoxy equivalent weight of 110 or less, and
   (a2) 10 to 60 mass % of an epoxy compound having a cyclic structure and an epoxy equivalent weight of 150 to 500.
5. The resin composition for a hollow fiber element tube sheet of clause 4, wherein the epoxy compound (a1) is a compound having three or more epoxy groups on its cyclic structure, and
   the epoxy compound (a2) is a bisphenol A epoxy compound.
6. The resin composition for a hollow fiber element tube sheet of any one of clauses 1 to 5, wherein the curing agent is an amine compound having the structure of formula (1):

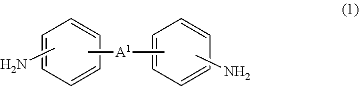

wherein A¹ represents a divalent linking group represented by any of formula (2-1), (2-2), (2-3), (2-4), and (2-5):

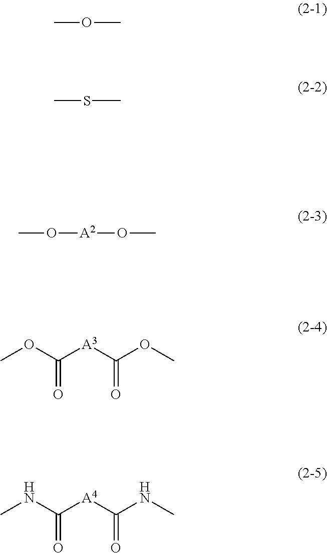

wherein A², A³, and A⁴ each independently represent a divalent organic group with 1 to 18 carbon atoms.
7. The resin composition for a hollow fiber element tube sheet of clause 6, wherein A¹ is a divalent linking group represented by any of formula (2-1), (2-2), and (2-3).
8. A hollow fiber element including a bundle of a plurality of hollow fiber membranes, the bundle having at least one of its ends fixed and adhered by a tube sheet formed of a cured product of the resin composition according to any one of clauses 1 to 7.
9. A separation membrane module including a pressure vessel and the hollow fiber element of clause 8 housed in the pressure vessel.
10. A gas separation system including the separation membrane module of clause 9.
11. A method for producing a dehydrated organic compound by the use of the gas separation system of clause 10.
12. A hollow fiber element for a separation membrane module, comprising
   a plurality of hollow fiber membranes, and
   a tube sheet which is formed of a cured product of an epoxy composition and
   fixes and adheres at least one of the ends of the hollow fiber membranes,
   wherein the cured product has a breaking strength retention of 75% or higher as measured in the form of a 0.2 mm thick film, the breaking strength retention R₁ (%) being defined as B₁/B₀×100,
   wherein B₁ is a breaking strength (MPa) measured at 23° C. after the film is immersed in ethanol at 130° C. for 120 hours; and
   B₀ is a breaking strength (MPa) measured at 23° C. before immersion in ethanol.

### EXAMPLES

The invention will now be illustrated in greater detail with reference to Examples, but it should be understood that the invention is not deemed to be limited thereto.

Compounds used in Examples were as follows.
Epoxy compound (a1): jER630, triglycidylaminophenol available from Mitsubishi Chemical, epoxy equiv.: 98
Epoxy compound (a2): jER828, liquid bisphenol A epoxy compound available from Mitsubishi Chemical; epoxy equiv.: 189
Epoxy compound (a3): jER604, tetraglycidyl diaminodiphenylmethane available from Mitsubishi Chemical, epoxy equiv.: 119
Curing agent (b1): WANAMINE MDA-100, 4,4′-diaminodiphenylmethane available from WANIHUA Chemical Group Co., Ltd., active hydrogen equiv.: 50
Curing agent (b2): 3,4′-diaminodiphenyl ether, active hydrogen equiv.: 50

### Preparation of a Cured Resin Composition

### Examples 1 to 8 and Comparative Examples 1 to 3

An epoxy composition and a curing agent were blended according to the composition of Table 1 (unit: part by mass) to prepare an uncured resin composition, and a cured product of the resin composition was obtained as follows.

### Method for Preparing Cured Product

The resin composition was cast into film. The cast film was heated at 60° C. all day (for 15 hours) to be cured primarily. Then, the temperature was elevated to 90° C. at a rate of 0.25° C./min, at which the film was heated for 2 hours, the temperature was further elevated to 120° C. at a rate of 0.25° C./min, at which the film was heated for 2 hours, the temperature was furthermore elevated to 150° C. at a rate of 0.25° C./min, at which the film was heated for 2 hours. Finally, the temperature was elevated to 180° C. at a rate of 0.25° C./min, at which the film was heated for 4 hours to give an approximately 0.2 mm thick cured film.

TABLE 1

| | | | | | | | | | | Comparative | | |
|---|---|---|---|---|---|---|---|---|---|---|---|---|
| | | Example | | | | | | | | Example | | |
| | | 1 | 2 | 3 | 4 | 5 | 6 | 7 | 8 | 1 | 2 | 3 |
| Epoxy | (a1) | 85 | 70 | 20 | 60 | 60 | 40 | 20 | 40 | 17 | 85 | 30 |
| Composition | (a2) | 15 | 30 | 20 | 20 | 40 | 60 | 60 | 20 | 15 | 15 | 70 |
| | (a3) | 0 | 0 | 60 | 20 | 0 | 0 | 20 | 40 | 68 | 0 | 0 |
| Curing | (b1) | 0 | 0 | 0 | 0 | 0 | 0 | 0 | 0 | 41 | 48 | 0 |
| Agent | (b2) | 48 | 45 | 41 | 45 | 42 | 37 | 35 | 43 | 0 | 0 | 34 |

The film made of the cured resin composition was evaluated in terms of breaking strength (a) in its initial state before heating, (b) after heating at 130° C. in the presence of ethanol, and (c) after heating at 150° C. The film was also evaluated in terms of elution ratio when swollen with ethanol. A cracking test was conducted on the resin compositions of Examples 1 and 2 and Comparative Example 1. The results obtained are shown in Table 2.

### Breaking Strength Measurement

A specimen having a width of approximately 6 mm and a length of approximately 40 mm was cut from the film of the cured resin composition. The breaking strength of the specimen was measured using a tensile tester Tensilon Universal Tester RTF-1350 from A& D Co., Ltd. at a pull speed of 2 mm/min and an initial jaw separation of 20 mm. The breaking strength measurement on the specimen in its initial state was carried out at 23° C. and 50% RH after conditioning the specimen at 23° C. and 50% RH for at least 10 hours. An average of the measurements of ten specimens, which is shown in Table 2, was taken as the breaking strength B₀ of the film in its initial state in the atmosphere.

A film specimen prepared in the same manner as described above was placed in a 50 ml airtight vessel made of polytetrafluoroethylene (PTFE). Then, 20 ml of ethanol was poured into the vessel, and the specimen was immersed in ethanol at 130° C. for 120 hours. Immediately after the immersion, the breaking strength of the specimen was measured, which was defined as the breaking strength B₁, i.e., the breaking strength after heating in the presence of ethanol.

A specimen prepared in the same manner as above was left to stand in an airtight vessel at 150° C. and 50% RH for 10 minutes. The breaking strength of the specimen measured immediately after it was taken out of the vessel was defined as the breaking strength B₂, i.e., the breaking strength after heating at 150° C.

### Elution Ratio Measurement

A specimen having a width of approximately 6 mm and a length of approximately 40 mm was cut from the 0.2 mm thick film of the cured resin composition. The specimen was weighed to give the weight before immersion. The specimen was immersed in ethanol in an airtight vessel at 130° C. for 120 hours. After the specimen was dried in vacuo at 120° C. for 72 hours, it was reweighed to give the weight after immersion. The difference in weight of the specimen between before and after immersion was divided by the weight before immersion, and the quotient was multiplied by 100 to yield the elution ratio.

### Cracking Test

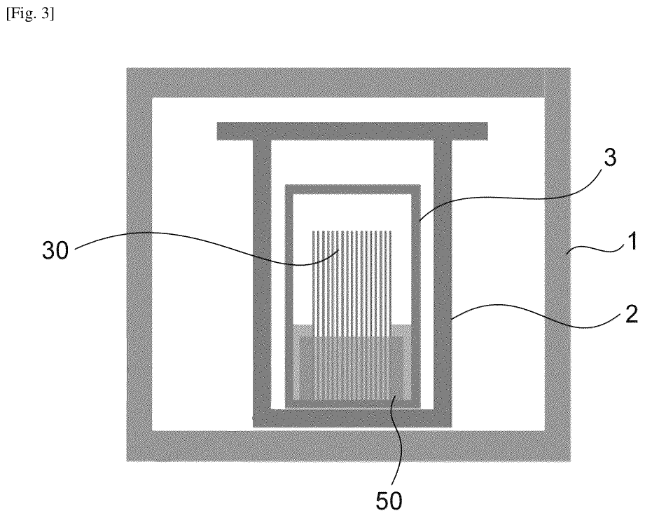

Reference is made to FIG. 3. A bundle 30 of 1230 hollow fibers each having a diameter of 0.5 mm and a membrane area of approximately 7.85×10⁻⁵ m² was prepared. A tube sheet 50 with a diameter of 28.8 mm is formed at one end of the bundle 30. This tube sheet was formed of the cured product of each of the resin compositions of Examples and Comparative Examples. The resulting hollow fiber element was placed in a PTFE inner container 3 with an inner diameter of 44 mm, and 40 mL of ethanol was poured into the inner container 3. The inner container 3 was then placed in a stainless steel pressure vessel 2, and the pressure vessel 2 was allowed to stand in a chamber 1 kept at 130° C. for 72 hours. Following exposure to ethanol, the hollow fiber element was dried at 130° C. for 72 hours under normal pressure. The tube sheet 50 after drying was visually examined and assigned a rating of “fail” if a crack was observed on the lateral side and/or at the interface with any hollow fiber, or “pass” when no cracks was detected on both the lateral side and the interface with any hollow fiber.

TABLE 2

| | | | | | | | | | Compara. | | |
|---|---|---|---|---|---|---|---|---|---|---|---|
| | Example | | | | | | | | Example | | |
| | 1 | 2 | 3 | 4 | 5 | 6 | 7 | 8 | 1 | 2 | 3 |
| Breaking | 52 | 43 | 39 | 36 | 55 | 46 | 46 | 38 | 56 | 47 | 72 |
| Strength B₀ | | | | | | | | | | | |
| (MPa) | | | | | | | | | | | |
| Breaking | 45 | 47 | 34 | 41 | 48 | 39 | 41 | 40 | 41 | 32 | 40 |
| Strength B₁ | | | | | | | | | | | |
| (MPa) | | | | | | | | | | | |
| Breaking | 32 | 27 | 30 | 28 | 30 | 29 | 31 | 32 | 29 | 24 | 32 |
| Strength B₂ | | | | | | | | | | | |
| (MPa) | | | | | | | | | | | |
| Breaking | 86 | 109 | 88 | 115 | 88 | 85 | 91 | 106 | 73 | 67 | 56 |
| Strength | | | | | | | | | | | |
| Retention R₁ | | | | | | | | | | | |
| (%) | | | | | | | | | | | |
| Breaking | 61 | 63 | 78 | 77 | 55 | 62 | 68 | 85 | 53 | 51 | 45 |
| Strength | | | | | | | | | | | |
| Retention R₂ | | | | | | | | | | | |
| (%) | | | | | | | | | | | |
| Elution | 0.5 | 0.9 | 2.0 | 0.3 | 1.3 | 1.6 | 1.2 | −0.4 | 4.7 | 5.1 | 2.3 |
| Ratio (%) | | | | | | | | | | | |
| Cracking | pass | pass | | | | | | | fail | | |
| Resistance | | | | | | | | | | | |

As demonstrated in Table 2, the cured products of the resin compositions of Examples with a breaking strength retention R₁ of 75% or higher have low elution ratios when immersed in an organic compound at high temperature and pressure. Furthermore, the tube sheets made of these cured product f the resin compositions undergo no cracking even after immersion in an organic compound under a high temperature and pressure condition, followed by drying. In contrast, the elution ratios in Comparative Examples, in which the breaking strength retention R₁ is lower than 75%, are very high. Furthermore, the tube sheet of Comparative Example 1 suffered cracking when immersed in an organic compound under a high temperature and pressure condition, followed by drying. Thus, it has been proved that using the resin composition of the invention to form a tube sheet for hollow fiber elements provides a tube sheet with excellent durability in the presence of high temperature and pressure organic vapor and a separation membrane module with improved gas-tightness retention.

### INDUSTRIAL APPLICABILITY

The invention provides a resin composition for hollow fiber element tube sheet, a hollow fiber element, and a separation membrane module which exhibit excellent durability in terms of elution and cracking resistance at high temperatures, particularly in the presence of high temperature and pressure organic vapor.

What is claimed is:

1. A hollow fiber element for a separation membrane module, comprising:
a plurality of hollow fiber membranes; and
a tube sheet which is formed of a cured product of an epoxy composition and fixes and adheres at least one of the ends of the hollow fiber membranes,
wherein the cured product has a breaking strength retention of 75% or higher as measured in the form of a 0.2 mm thick film, wherein the breaking strength retention (%) is defined as B₁/B₀×100,
wherein B₁ is a breaking strength (MPa) measured at 23° C. after the film is immersed in ethanol at 130° C. for 120 hours; and
B₀ is a breaking strength (MPa) measured at 23° C. before the film is immersed in ethanol.

2. The hollow fiber element according to claim 1, wherein the cured product has an alcohol elution ratio of 2% or lower when immersed in ethanol at 130° C. for 120 hours in the form of a 0.2 mm thick film.

3. The hollow fiber element according to claim 1, wherein the cured product has a breaking strength B₀ of 30 MPa or more as measured in the form of a 0.2 mm thick film.

4. The hollow fiber element according to claim 1, where the tube sheet is formed of a cured product of a resin composition comprising the epoxy composition and a curing agent.

5. The hollow fiber element according to claim 1, wherein the epoxy composition comprises:
(a1) 20 to 90 mass % of an epoxy compound having a cyclic structure and an epoxy equivalent weight of 110 or less; and
(a2) 10 to 60 mass % of an epoxy compound having a cyclic structure and an epoxy equivalent weight of 150 to 500.

6. The hollow fiber element according to claim 5, wherein the epoxy compound (a1) is compound having three or more epoxy groups on its cyclic structure, and the epoxy compound (a2) is a bisphenol A epoxy compound.

7. The hollow fiber element according to claim 4, wherein the curing agent is an amine compound having the structure of formula (1): 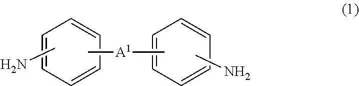
wherein A¹ represents a divalent linking group represented by any one of formulas (2-1), (2-2), (2-3), (2-4), and (2-5): 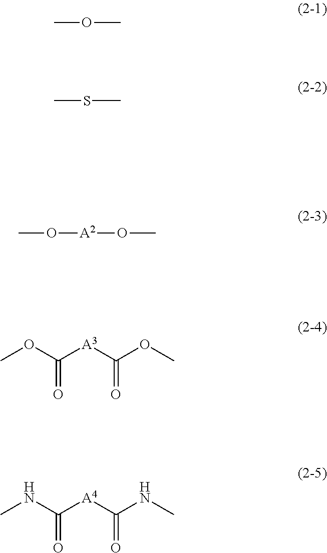
wherein A², A³, and A⁴ each independently represent a divalent organic group having 1 to 18 carbon atoms.

8. The hollow fiber element according to claim 7, wherein A¹ is a divalent linking group represented by any of formulas (2-1), (2-2), and (2-3).

9. The hollow fiber element according to claim 7, wherein A¹ is a divalent linking group represented by formula (2-1).

10. The hollow fiber element according to claim 7, wherein, in formula (1), at least one of the two amino groups is in the m-position relative to the linking group A¹ bonded to the benzene ring to which the amino group is bonded.

11. The hollow fiber element according to claim 5, wherein the epoxy compound (a1) is a compound having three or more epoxy groups on its cyclic structure, and the epoxy composition further comprises (a3) 60 mass % or less of an epoxy compound having two or more cyclic structures and an epoxy equivalent weight of less than 150.

12. The hollow fiber element according to claim 11, wherein the epoxy compound (a3) is represented by formula (5): 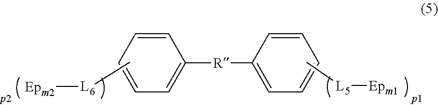
wherein Ep represents an epoxy group; R″ represents a methylene group or —C(R″′)₂—; each R″′ represents an alkyl group having 1 to 3 carbon atoms, a fluoroalkyl group having 1 to 3 carbon atoms, or a hydrogen atom; m1, p1, m2, and p2 each represent 1 or 2, provided that m1+p1=3 and m2+p2=3; L₅ represents an (m1+1)-valent group; and L₆ represents an (m2+1)-valent group.

13. A separation membrane module comprising a pressure vessel, and the hollow fiber element according to claim 1 housed in the pressure vessel.

14. A gas separation system comprising the separation membrane module according to claim 13.

15. A method for producing a dehydrated organic compound comprising using the gas separation system according to claim 14.
